(19) United States
(12) Patent Application Publication
(10) Pub. No.: US 2004/0034979 A1
(43) Pub. Date: Feb. 26, 2004

(54) Wear strip replacement method and apparatus

(76) Inventor: Micheal Edward Englot, Dawson Creek (CA)

Correspondence Address: Stacey C. Slater, KLARQUIST SPARKMAN, LLP, One World Trade Center, Suite 1600, 121 S. W. Salmon street, Portland, OR, 97204, US

(21) Appl. No.: 10/225,711

(22) Filed: Aug. 21, 2002

(51) Int. Cl. B23P 6/00; B29C 73/00

(52) U.S. Cl. 29/402.01

(57) ABSTRACT

The invention provides a method of replacing a worn wear strip located between a rail and a retaining plate, the method comprising positioning a new wear strip adjacent the worn wear strip, securing a clamping apparatus to the rail adjacent the new wear strip opposite the worn wear strip and urging the rail in a direction from the clamping apparatus to the retaining plate until the clamping apparatus abuts the retaining plate, the new wear strip pushing the worn wear strip from its position between the rail and the retaining plate. The invention also provides a clamping apparatus configured to be secured to a rail, the clamping apparatus comprising first and second flanges and a spacer, the first and second flanges and spacer all having at least one bolt hole therethrough, and at least one bolt inserted through the at least one bolt hole.

### TECHNICAL FIELD

This invention relates to a novel method and apparatus for replacing wear strips. More particularly, it relates to a method and apparatus for replacing a wear strip located between a moldboard rail attached to a grader blade and retaining plates connected to a grader's frame.

### BACKGROUND

A grader typically has a blade on the underside thereof which is used for scraping the ground. The blade is typically moveable with respect to the grader, both laterally and rotationally. To facilitate lateral movement of the blade relative to the grader, the blade generally has one or more moldboard rails thereon. The front side of the blade is concave, and the moldboard rails are attached to the rear (convex) side of the blade. The moldboard rails are held in place between retaining plates which are operably connected to the frame of the grader, such that the blade may be moved from side to side (“sideshifted”), generally by hydraulic means. Wear strips are located between the moldboard rails and retaining plates to extend the useful life of the moldboard rails and retaining plates by protecting them from wear and tear. The wear strips are frictionally held by the retaining plates, and allow the rails to slide against them as the blade is sideshifted back and forth.

According to the prior art, in order to replace the wear strips, a worker must first orient the blade so that it is perpendicular relative to the direction of travel of the grader, lower the blade to the ground and shut off the grader. The retaining plates are removed and the wear strips are replaced, and then shims must be inserted between the moldboard rails and the wear strips to provide a manufacturer specified minimum clearance between the wear strips and the blade. The retaining plates are replaced and the grader is restarted, and then the blade is sideshifted through its entire range of motion to ensure that the minimum clearance exists between the wear strips and the blade.

The above method of replacing wear strips is time consuming and leaves room for operator error. There exists a need for a more efficient and reliable way to replace wear strips.

### SUMMARY OF THE INVENTION

The invention provides a method of replacing a worn wear strip located between a rail and a retaining plate. The method comprises positioning a new wear strip adjacent the worn wear strip. securing a clamping apparatus to the rail adjacent the new wear strip opposite the worn wear strip and moving the rail in a direction from the clamping apparatus towards the retaining plate until the clamping apparatus abuts the retaining plate. The new wear strip pushes the worn wear strip from its position between the rail and the retaining plate.

The clamping apparatus may comprise a spacer between two flanges, with bolts inserted through the flanges and the spacer, and securing the clamping apparatus may comprise positioning the flanges on either side of the rail and tightening the bolts.

The spacer comprises a plurality of plates, and securing the clamping apparatus may comprise selecting plates to make up the plurality of plates such that the spacer has a width slightly less than a width of the rail.

Moving the rail may be accomplished by hydraulic means.

The invention also provides a clamping apparatus configured to be secured to a rail. The clamping apparatus comprises first and second flanges and a spacer. The first and second flanges and spacer preferably all have at least one bolt hole therethrough, and at least one bolt inserted through the at least one bolt hole.

The at least one bolt hole through at least one of the first and second flanges may be threaded to secure the at least one bolt therein. Alternatively, the clamping apparatus may comprise at least one nut, wherein the at least one bolt is threaded through the at least one nut.

The spacer may comprise a plurality of plates.

### BRIEF DESCRIPTION OF DRAWINGS

In drawings which illustrate non-limiting embodiments of the invention:

FIG. 1 illustrates one end of a grader blade held in place by retaining plates with a clamping apparatus and a new wear strip positioned on one of the moldboard rails, according to a preferred embodiment of the invention;

FIG. 2 illustrates an enlarged view of the area indicated by numeral II in FIG. 1;

FIG. 3 illustrates a clamping apparatus according to another embodiment of the invention;

FIG. 4 is an exploded view of the clamping apparatus of FIG. 3.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

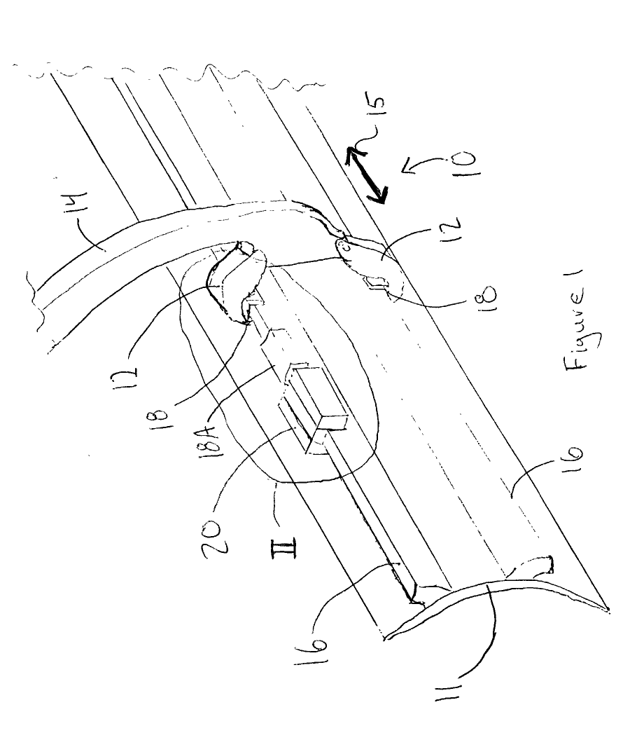

FIG. 1 shows one end 11 of a grader blade 10 held in place by upper and lower retaining plates 12. Retaining plates 12 are attached to arm 14 which is connected to the grader's frame (not shown). Retaining plates 12 may be hingedly attached to arm 14 so that blade 10 may be removed or replaced. A second arm may be located near the opposite end of blade 10 (not shown). Hydraulic means (not shown) may be coupled to blade 10 to move blade 10 from side to side, as indicated by double arrow 15. Generally, one end of a hydraulic cylinder is attached to arm 14 and the other end is attached to blade 10.

Blade 10 comprises upper and lower moldboard rails 16 which may be gripped by retaining plates 12. A wear strip 18 is located between each retaining plate 12 and its respective rail 16.

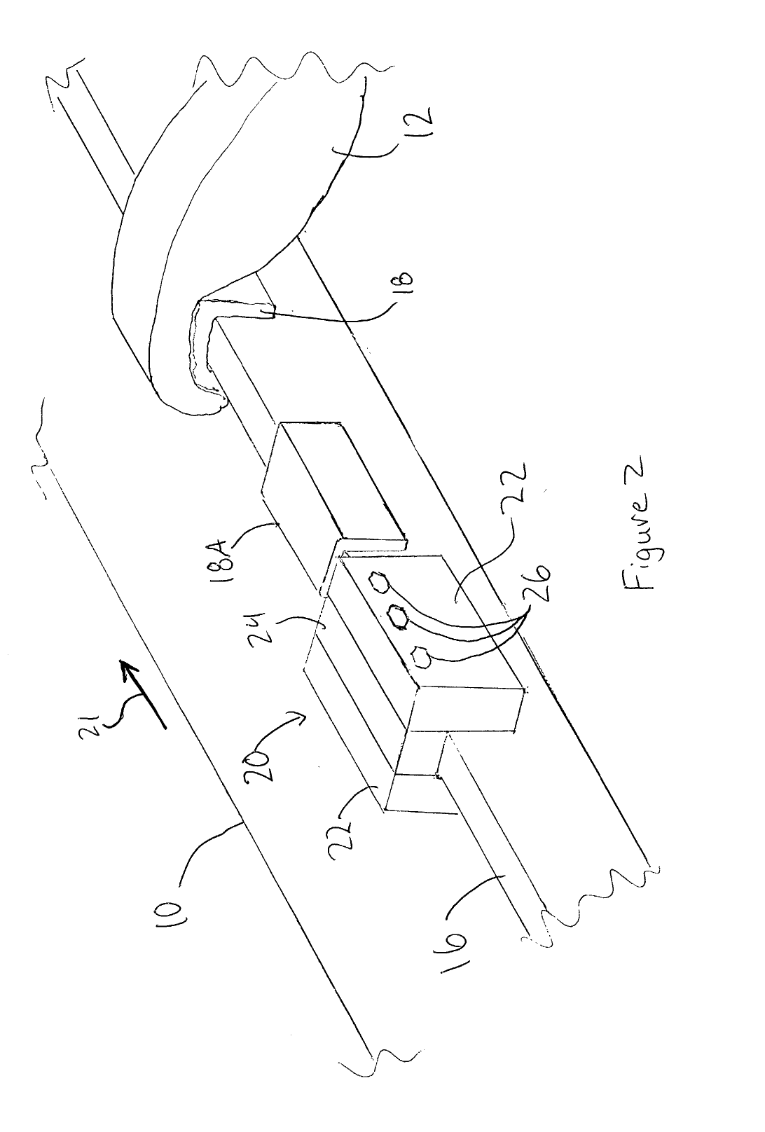

As best seen in FIG. 2, to replace wear strip 18, the user positions a new wear strip 18A adjacent wear strip 18 on rail 16. Throughout the description and claims, the term “adjacent”, as applied to two objects, shall be understood to mean that the two objects are near another, without another object between them, but shall not imply that the two objects are necessarily in contact. Clamping apparatus 20 is secured to rail 16 adjacent new wear strip 18A.

New wear strip 18A is held in place by gravity when positioned on the upper rail 16. To attach a new wear strip 18A to the lower rail 16, one worker holds new wear stip 18A in place as another worker moves blade 10, as described below.

A worker operates the hydraulic means (not shown) to move blade 10 in the direction indicated by arrow 21 in FIG. 2 so that end 11 moves towards arm 14. As blade 10 moves in the direction indicated by arrow 21, clamping apparatus 20 urges new wear strip 18A towards wear strip 18. When replacing wear strip 18 on the lower rail 16, a worker must hold new wear stip 18A against rail 16 until clamping apparatus 20 abuts new wear strip 18A and new wear strip 18A abuts wear strip 18. New wear strip 18A forces wear strip 18 out from under retaining plate 12. When clamping apparatus 20 abuts retaining plate 12, the user stops the movement of blade 10. New wear strip 18A is now held in place between rail 16 and retaining plate 12, in the same position previously occupied by wear strip 18.

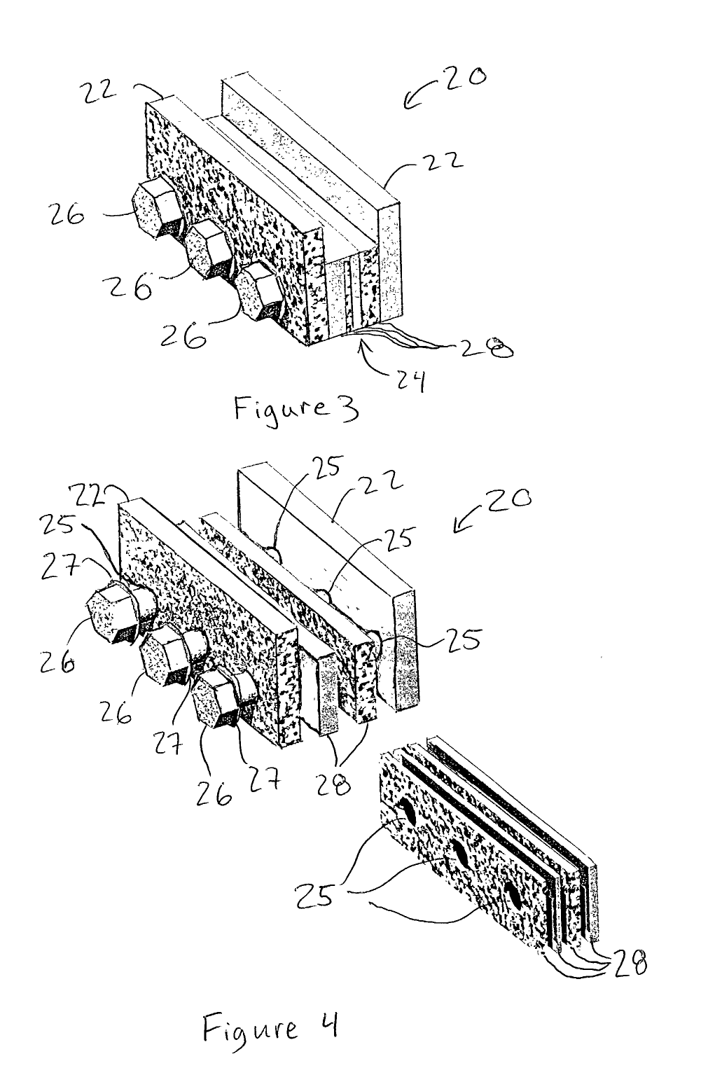

Clamping apparatus 20 preferably comprises flanges 22, spacer 24 and bolts 26. Flanges 22 and spacer 24 define bolt holes 25 to accommodate bolts 26. Three bolts 26 are shown in the Figures, but it is to be understood that the invention will function so long as at least one bolt 26 (and corresponding bolt hole) is provided. Preferably, bolt holes 25 in flange 22 opposite the heads of bolts 26 are threaded to secure bolts 26 therein, but in the alternative, nuts (not shown) may be provided to secure bolts 26. Washers 27 may be positioned between the heads of bolts 26 and flange 22. Spacer 24 may comprise a plurality of plates 28, as shown in FIGS. 3 and 4. Plates 28 preferably have a variety of different widths. The user may vary the width of spacer 24 by selecting different plates 28 to comprise spacer 24. Clamping apparatus 20 is secured to rail 16 by selecting plates 28 so that spacer 24 has a width slightly less than the width of rail 16, placing flanges 22 over the edges of rail 16 and tightening bolts 26.

Alternatively, spacer 24 may be a single unit with a width slightly less than the width of rails 16 of a specific grader. As a further alternative, spacer 24 may be permanently attached to one of the flanges 22, or a portion of spacer 24 may be permanently attached to each of flanges 22.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of replacing a worn wear strip located between a rail and a retaining plate, the method comprising
(a) positioning a new wear strip adjacent the worn wear strip;
(b) securing a clamping apparatus to the rail adjacent the new wear strip opposite the worn wear strip; and,
(c) moving the rail in a direction from the clamping apparatus towards the retaining plate until the clamping apparatus abuts the retaining plate, the new wear strip pushing the worn wear strip from its position between the rail and the retaining plate.

2. The method of claim 1 wherein the clamping apparatus comprises a spacer between two flanges, with bolts inserted through the flanges and the spacer, and wherein securing the clamping apparatus comprises positioning the flanges on either side of the rail and tightening the bolts.

3. The method of claim 2 wherein the spacer comprises a plurality of plates, and wherein securing the clamping apparatus comprises selecting plates to make up the plurality of plates such that the spacer has a width slightly less than a width of the rail.

4. The method of claim 1 wherein moving the rail is accomplished by hydraulic means.

5. A clamping apparatus configured to be secured to a rail, the clamping apparatus comprising first and second flanges and a spacer, the first and second flanges and spacer all having at least one bolt hole therethrough, and at least one bolt inserted through the at least one bolt hole.

6. The clamping apparatus of claim 5 wherein the at least one bolt hole through at least one of the first and second flanges is threaded to secure the at least one bolt therein.

7. The clamping apparatus of claim 5 further comprising at least one nut, wherein the at least one bolt is threaded through the at least one nut.

8. The clamping apparatus of claim 5 wherein the spacer comprises a plurality of plates.

9. The clamping apparatus of claim 5 wherein the spacer comprises a sinngle unit.

10. The clamping apparatus of claim 5 wherein the spacer is permanently attached to one of the flanges.

11. The clamping apparatus of claim 5 wherein a first portion of the spacer is permanently attached to the first flange and a second portion of the spacer is permanently attached to the second flange.
